(19) United States
(12) Patent Application Publication
(10) Pub. No.: US 2013/0147122 A1
(43) Pub. Date: Jun. 13, 2013

(54) SEALING MEMBER COMPRISING WOVEN FABRIC

(71) Applicants: Susumu Shoji, Kobe-shi (JP); Kazuro Fukui, Kobe-shi (JP)

(72) Inventors: Susumu Shoji, Kobe-shi (JP); Kazuro Fukui, Kobe-shi (JP)

(73) Assignees: SANWA TECHNO CO., LTD, Kobe-shi, Hyogo (JP); Susumu Shoji, Kobe-shi, Hyogo (JP)

(21) Appl. No.: 13/696,203

(22) PCT Filed: May 5, 2010
(86) PCT No.: PCT/JP2010/057726

§ 371 Date: Feb. 19, 2013

(51) Int. Cl. G03G 21/00

(52) U.S. Cl. CPC G03G 21/00
USPC 277/345

(57) ABSTRACT

A sealing member for preventing leakage of powder from a rotating body, can prevent escape of powder under low load and with little yarn, which has excellent wear resistance.

In the context of a sealing member (1) for preventing leakage of powder (6), a sealing member (1) made up of at least three or more types of woven yarn and formed from woven fabric comprising warp yarn (3a) and weft yarn (3c), the warp yarn (3a) in this sealing member (1) comprising at least two or more types of different yarn diameters (3g) and densities. This is a sealing member (1) for preventing leakage of powder (6) comprising formation of the sealing member (1) from fabric woven in a pattern (2b) of banded and striped appearance (4) having steps (5) due to the difference in diameters and difference in densities of these warp yarns (3a).

### TECHNICAL FIELD

The present invention relates to a sealing member used to prevent toner or other such powder from leaking to the exterior from an end of a powder carrier which is a rotating body in an apparatus that utilizes powder, such as, for example, a copy machine, printer, or other such electrophotographic image forming apparatus.

### BACKGROUND ART

Conventional sealing members include sealing members comprising foamed bodies, sealing members comprising nonwoven fabrics, sealing members comprising implanted fibers, sealing members comprising piled woven fabrics, sealing members comprising other types of woven fabric, sealing members comprising knit fabrics, and so forth. Such sealing members are often used as end seal members in powder carriers where surfaces of powder carriers constituting rotating bodies are partially exposed.

As a structure of an end seal member at a rotating body, a structure is disclosed in which there is a sheet over which another inclined sheet is affixed to form a step, and this step is made to serve as powder guide to control leakage of powder (e.g., see Patent Reference No. 1).

Furthermore, sealing members have also been disclosed structures in which grooves are provided (e.g., see Patent Reference No. 2). Moreover, sealing structures have also been disclosed in which steps serving as guides are applied by printing on end sheet members (e.g., see Patent Reference No. 3).

Pile-woven seal members which are woven fabrics have been disclosed (e.g., see Patent Reference No. 4 and Patent Reference No. 5), and furthermore, seal members which are knit fabrics have been disclosed (e.g., see Patent Reference No. 6).

Moreover, sealing members which are not pile-woven but which are woven fabrics have been disclosed (e.g., see Patent Reference No. 7 and Patent Reference No. 7).

However, in the foregoing conventional art, among art at which flow is controlled and leakage is prevented to prevent leakage of developer, toner, or other such powder, there being a sheet over which a sheet serving as guide is affixed, there has been concern that many manufacturing steps might therefore be required or that the affixed guide might become detached therefrom. Furthermore, at seal members comprising rubber provided with grooves, the fact that a die has been required for manufacture thereof and initial cost has been high has caused product cost to be high, while at the same time, it having been necessary to employ materials having good sliding characteristics or to apply a coating having good sliding characteristics relative to rubber sealing members, these cannot be said to have been satisfactory from the standpoint of cost.

Moreover, in recent years, as particle diameter of powders constituting toner has decreased in size, sealing members employing pile have come to be been more frequently. Now, such sealing members employing pile may be manufactured by electrostatic fiber insertion, pile weaving, warp knitting, plating pile knitting, and so forth. However, with electrostatic fiber insertion, prevention of loss of fibers and stabilization of density is difficult, and it is necessary to increase density of pile to achieve stabilization. As a result, pile length is made short, being approximately 1 mm, such that, conversely, load with which the develop roller is abutted thereby increases, as a result of which, when a develop roller comprising soft rubber roller is employed, this causes wear of the develop roller, and has moreover caused occurrence of problems in that pile is lost due to having been rubbed thereby.

Moreover, with pile weaving, sealing members constituted from woven fabric or knit fabric are such that require a large number of operations, including a pile cutting operation, a fiber grooming operation for controlling flow of powder, and so forth, which increases manufacturing cost, and moreover, there is scattering of pile during cutting and raggedness produced when this is cut into the desired shape during the manufacturing process, as a result of which ingenuity has been required with respect to manufacturing aspects. A large amount of yarn is also required to constitute pile.

On the other hand, with respect to woven fabrics which do not have cut pile, the disclosure at Patent Reference No. 5 is such that yarn is raised in wavelike fashion, peaks and valleys being arranged so as to be at different locations. However, woven fabric constituted in such wavelike fashion has been of unstable constitution as woven fabric, and has not been satisfactory as a sealing member. Moreover, disclosed at Patent Reference No. 7 or Patent Reference No. 8 is pile arrayed with inclined configuration so as to form a prescribed angle relative to a direction of motion of a develop carrier. Furthermore, the disclosures at this Patent Reference No. 7 or this Patent Reference No. 8 are such that a step at an overlapping portion is arranged in controlled fashion, and moreover, an inclined configuration is imparted thereto as described above. However, these have depended to too great an extent on the overlapping portion, and have not been of adequate constitution for controlling flow of powder. Grease-like preparations of fluorinated lubricants have therefore been applied to surface portions of sealing members to improve the seal characteristics thereof, but it cannot be said that these have always been adequate as sealing members.

### PRIOR ART REFERENCES

### Patent References

Patent Reference No. 1: Japanese Patent Application Publication Kokai No. H2[1990]-210476
Patent Reference No. 2: Japanese Patent Application Publication Kokai No. H9[1997]-274380
Patent Reference No. 3: Japanese Patent Application Publication Kokai No. 2000-170919
Patent Reference No. 4: Japanese Patent Application Publication Kokai No. H11[1999]-143326
Patent Reference No. 5: Japanese Patent Application Publication Kokai No. H11[1999]-194612
Patent Reference No. 6: Japanese Registered Utility Model No. 3065136
Patent Reference No. 7: Japanese Patent Application Publication Kokai No. 2003-107902
Patent Reference No. 8: Japanese Patent Application Publication Kokai No. 2007-179080

### SUMMARY OF INVENTION

### Problem to be Solved by Invention

A problem to be solved by the present invention is to provide a sealing member, particularly a sealing member which will prevent leakage of toner from a rotating body in an electrophotographic apparatus, that will solve the foregoing problems and inadequacies of conventional sealing members, that will make it possible to prevent escape of powder even under low load and with a member employing little yarn, that does not require grooming of fibers or procedures to achieve uniform sealing member height as is the case with conventional sealing members, that does not require trimming to remove raggedness occurring on sealing member surfaces, that has excellent wear resistance, and that does not pose a risk with respect to detachment from a location at which the sealing member has been arranged.

### Means for Solving Problem

As means in accordance with the present invention for solving the foregoing problem, a means in accordance with claim 1, in the context of a sealing member for preventing leakage of powder, is a woven fabric sealing member comprising warp yarn and weft yarn, being woven from at least three or more types of yarn. This warp yarn in this sealing member comprises at least two or more different yarn diameters and densities. This is a sealing member for preventing leakage of powder woven fabric characterized in that the sealing member is formed from woven fabric woven into a pattern having banded and striped appearance having steps due to this difference in warp yarn diameters and this difference in densities.

At a means in accordance with claim 2, the woven fabric woven into a pattern having banded and striped appearance having steps is such that the pattern of banded and striped appearance is formed from steps between high-thickness sides and low-thickness sides. The high-thickness side of each of these steps is formed such that not less than three woven warp yarns comprising spun continuous yarn formed by spinning a plurality of continuous fibers and/or spun discontinuous yarn formed by spinning a plurality of discontinuous fibers are arranged in continuously adjacent and/or proximate fashion so that the warp yarn density in the weft direction is higher than at the low-thickness side, as a result of which flattening of the warp yarn cross-section and/or spreading of fibers forming the warp yarn is suppressed, and deformation in the warp yarn height direction is decreased. On the other hand, the low-thickness side of each of these steps is formed such that low warp yarn density, due to there being not more than two woven warp yarns comprising spun continuous yarn and/or spun discontinuous yarn for which there is little tendency toward suppression of spreading of fibers forming the warp yarn and/or flattening of cross-section, causes spreading of fibers forming the warp yarn and/or flattening in a direction such as will increase width of the warp yarn to be promoted more than at the high-thickness side, and causes height in the thickness direction to be decreased. This is a sealing member for preventing leakage of powder comprising woven fabric in accordance with the means at claim 1 characterized in that alternating arrangement of locations at which there are these two different warp yarn densities causes the woven pattern to be of banded and striped appearance having steps from difference in height in the thickness direction due to degree of spreading of fibers that form the warp yarn and/or degree of flattening constituting difference in deformation in the thickness direction.

At a means in accordance with claim 3, the not less than three woven warp yarns comprising spun continuous yarn formed by spinning a plurality of continuous fibers and/or spun discontinuous yarn formed by spinning a plurality of discontinuous fibers are formed from woven spun continuous yarn and/or woven spun discontinuous yarn having larger warp yarn diameter at the high-thickness sides than warp yarn diameter at the low-thickness sides which form the woven pattern of banded and striped appearance having steps. Moreover, this is a sealing member for preventing leakage of powder comprising woven fabric in accordance with the means at claim 2 characterized in that a woven mesh of banded and striped appearance in which not less than three of these woven warp yarns comprising continuous yarn and/or discontinuous yarn having large diameter are arranged in proximate and/or adjacent fashion is formed so as to bend less easily than a woven mesh comprising not more than two woven warp yarns comprising yarn having small diameter.

At a means in accordance with claim 4, when the woven fabric comprising the woven pattern of banded and striped appearance having steps is used as a sealing member in an application at a rotating body, the sealing member is formed by cutting and/or punching that woven pattern so as to cause a direction of the bands and stripes to be inclined at a prescribed control angle relative to a direction of rotation of the rotating body at which it is employed. In addition, this is a sealing member for preventing leakage of powder comprising woven fabric in accordance with the means at claim 3 characterized in that causing this sealing member to abut an end portion of a powder carrier which constitutes the rotating body prevents leakage of powder to the exterior from a location between a region abutted by the sealing member and the powder carrier which constitutes the rotating body.

At a means in accordance with claim 5, this is a sealing member for preventing leakage of powder comprising woven fabric in accordance with the means at claim 4 characterized in that a foamed body and/or an elastic body having cushioning characteristics is arranged at a back of the sealing member formed so as to be inclined at the prescribed control angle relative to the direction of rotation of the rotating body at which it is employed, and leakage of powder is prevented as a result of application of a prescribed load.

At a means in accordance with claim 6, this is a sealing member for preventing leakage of powder comprising woven fabric in accordance with the means at any one of claims 1 through 5 characterized in that the sealing member for preventing leakage of powder comprising woven fabric is such that, on a surface of woven yarn comprising spun discontinuous yarn formed by spinning a plurality of discontinuous fibers or spun continuous yarn formed by spinning a plurality of continuous fibers or monofilament yarn constituting continuous fibers from which that sealing member is formed, there is a film formed by rubbing thereon a waxy substance comprising an ester of a higher alcohol and a higher fatty acid which is a wax and/or a paraffin or a fatty acid salt constituting metallic soap and/or bar soap comprising solid matter.

At a means in accordance with claim 7, this is a sealing member for preventing leakage of powder comprising woven fabric in accordance with the means at any one of claims 1 through 6 characterized in that the sealing member for preventing leakage of powder comprising woven fabric is a sealing member at a powder carrier constituting a rotating body in an electrophotographic apparatus.

### BENEFIT OF THE INVENTION

Because it comprises plain weave constituting woven fabric imparted with stepped structure, the sealing member in accordance with the means of the present invention is a structure that makes efficient use of resources, as it permits attainment of high performance as a seal while using little yarn, and as it is an extremely high-quality sealing member, being constituted from few operations, without need for operations in which fibers are groomed or shirring operations to achieve uniform height, and without production of raggedness during use, and as it permits stable use, with no concern with respect to loss of fibers, and as it moreover has excellent wear resistance, and there is also no worry with respect to detachment, and so forth.

### BRIEF DESCRIPTION OF THE DRAWINGS

FIG. 1 Schematic plan view showing weaving pattern at woven fabric in a sealing member in accordance with the present invention.

FIG. 2 Side view as seen in the weft yarn direction from a high-thickness side of a step in the weaving pattern shown in plan view at FIG. 1.

FIG. 3 Schematic plan view showing another weaving pattern at woven fabric in a sealing member in accordance with the present invention.

FIG. 4 Side view as seen in the direction of the warp yarn at the left side of the weaving pattern shown in plan view at FIG. 3.

FIG. 5 Schematic side view showing cross-section of both warp yarns in a weaving pattern in which warp yarn woven in a pattern of high density, warp yarn woven in a pattern of low density, and weft yarn are all monofilament yarns.

FIG. 6 Schematic side view showing cross-section of both warp yarns in a weaving pattern in which warp yarn woven in a pattern of high density and warp yarn woven in a pattern of low density are each multifilament yarns comprising a plurality of fibers, and weft yarn is monofilament yarn.

FIG. 7 Schematic plan view of woven fabric made in plain weave at a sealing member in accordance with the present invention.

FIG. 8 Plan view showing width W at the high side of a step and pitch P at stripes in a sealing member in accordance with the present invention.

FIG. 9 Schematic side view of a vibration testing machine.

FIG. 10 Schematic plan view showing three sealing members having different control angles at the stripes thereof.

FIG. 11 Schematic side view of a developing device in an electrophotographic apparatus.

FIG. 12 Schematic front view of an end portion of a develop roller at which a sealing member is attached.

FIG. 13 Schematic side view showing in exploded fashion a develop roller at a developing device in an electrophotographic apparatus and how a sealing member is attached thereto.

FIG. 14 Shows front view of sealing member at left, and side view thereof at right.

FIG. 15 Schematic side view of end portion of a develop roller showing how a toner control blade is attached to the end portion.

FIG. 16 At center is a plan view showing how stock material is utilized when sealing members are to be formed by punching from woven fabric for which the control angle is set to 10°; at left is a side view thereof as seen from the left; and at right is a plan view of a sealing member at which control angle is 10°.

FIG. 17 At center is a plan view showing how stock material is utilized when sealing members are to be formed by punching from woven fabric for which the control angle is set to 45°; at left is a side view thereof as seen from the left; and at right is a plan view of a sealing member at which control angle is 45°.

FIG. 18 Side view showing how an end seal member is arranged so as to abut a photosensitive drum or other such member being cleaned.

FIG. 19 Schematic front view in which the photosensitive drum has been omitted to show the situation that exists at an end where an end seal member is arranged below a blade support member and a cleaning blade is arranged behind the end seal member.

### EMBODIMENTS FOR CARRYING OUT THE INVENTION

Embodiments of a sealing member (1) in accordance with the present invention are described below with reference to the tables and drawings.

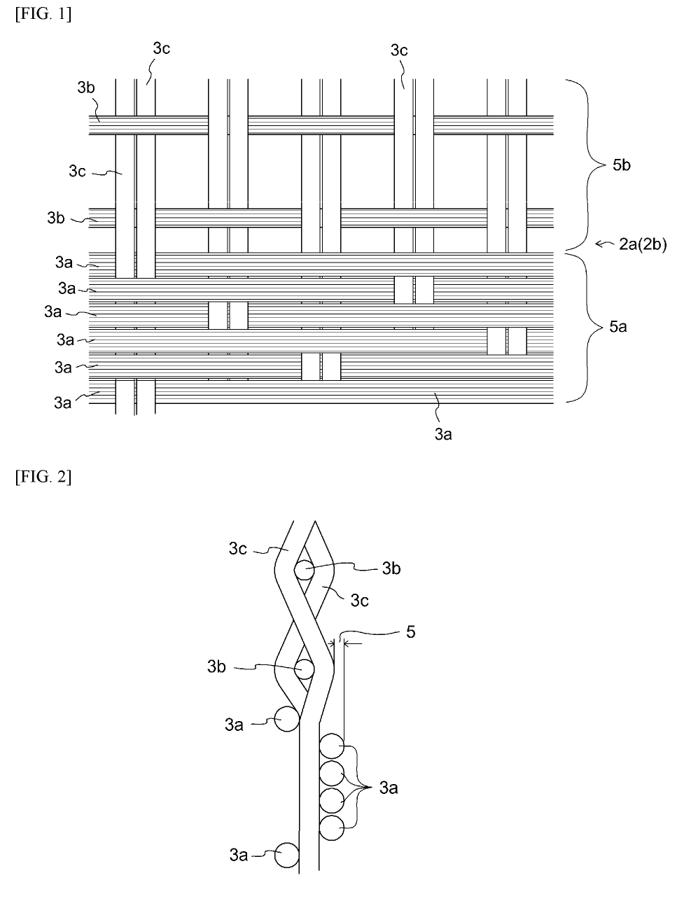

An embodiment in accordance with claim 1 of the present invention will first be described. This is a sealing member (1) formed from woven fabric that acts to prevent leakage of powder (6) to the exterior from rotating body (7) or shaft portion (9). This sealing member is made up of at least three or more types of woven yarn, being formed from woven fabric made in plain weave (2a) from warp yarn (3a) woven in a pattern of high density, warp yarn (3b) woven in a pattern of low density, and weft yarn (3c) that crosses these. The warp yarn (3a) woven in a pattern of high density and warp yarn (3b) woven in a pattern of low density, these being yarns of the woven fabric that forms this sealing member (1), comprise at least two or more different yarn diameters (3g) and densities. The difference in densities and the difference in yarn diameter (3g) at this warp yarn (3a) woven in a pattern of high density and yarn diameter (3g) at this warp yarn (3b) woven in a pattern of low density are such that weaving of the woven fabric produces a woven pattern (2b) of banded and striped appearance (4) in which steps (5) are present. An enlarged view of the woven pattern (2b) at a location corresponding to a site of such striped appearance (4) in the plain weave (2a) is shown in schematic fashion at FIG. 1.

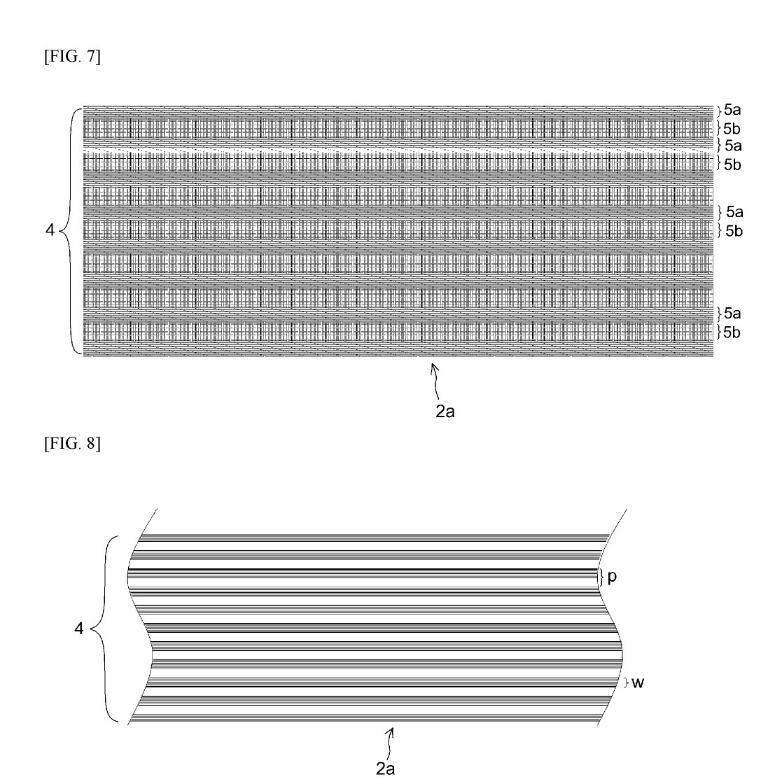

At the high-thickness side (5a) of the step (5), i.e., where warp yarns (3a) woven in a pattern of high density are present, the woven pattern (2b) of the plain weave (2a) having striped appearance (4) shown in FIG. 1 is formed from six warp yarns (3a) and two weft yarns (3c), plain weave (2a) being formed in such fashion that that sets of four, three, and two, i.e., three varieties of sets, of these six warp yarns (3a) alternately appear at the front side at locations which move in a horizontal direction, in accompaniment to which sets of two adjacent weft yarns (3c) appear between warp yarns (3a) at the front side at locations which move in a vertical direction. On the other hand, at the low-thickness side (5b) of the step (5), i.e., where warp yarns (3b) woven in a pattern of low density are present, plain weave (2a) is formed in such fashion that sets of single warp yarns (3b) alternately appear at the front side between sets of two adjacent weft yarns (3c). Moreover, the high-thickness side (5a) of the step (5) and the low-thickness side (5b) of the step (5) which are formed in this manner are formed in alternating fashion to form the banded and striped appearance (4) shown in FIG. 7, thus forming the woven fabric comprising the plain weave (2a) from which the sealing member (1) is formed. Here, FIG. 1 shows a plan view of a plain weave (2a) used to form a sealing member (1) in accordance with the present invention, and FIG. 2 shows a side view as seen from the left side of FIG. 1.

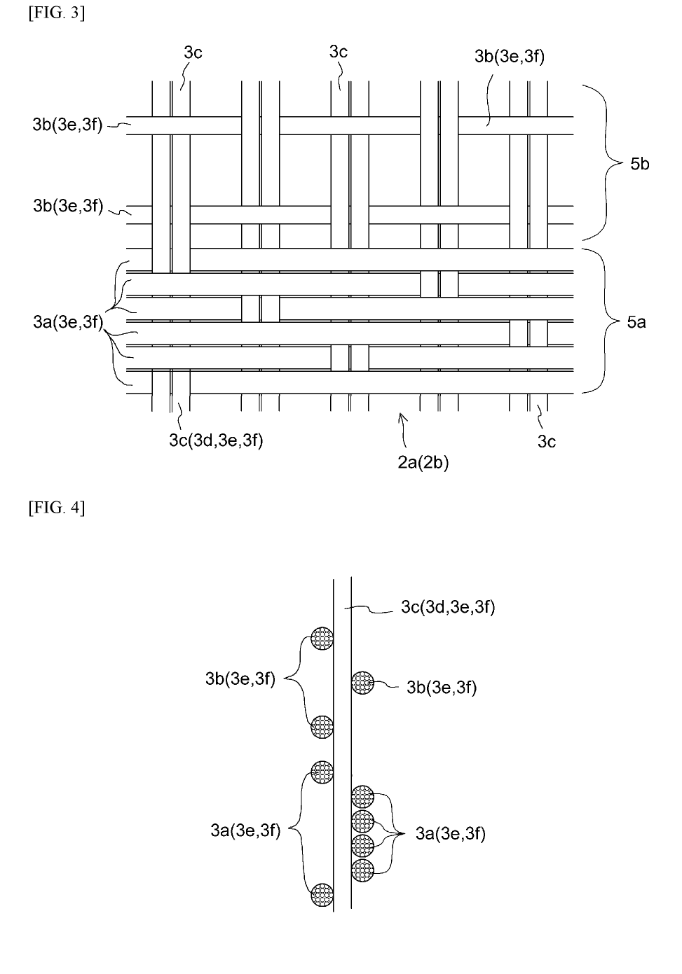

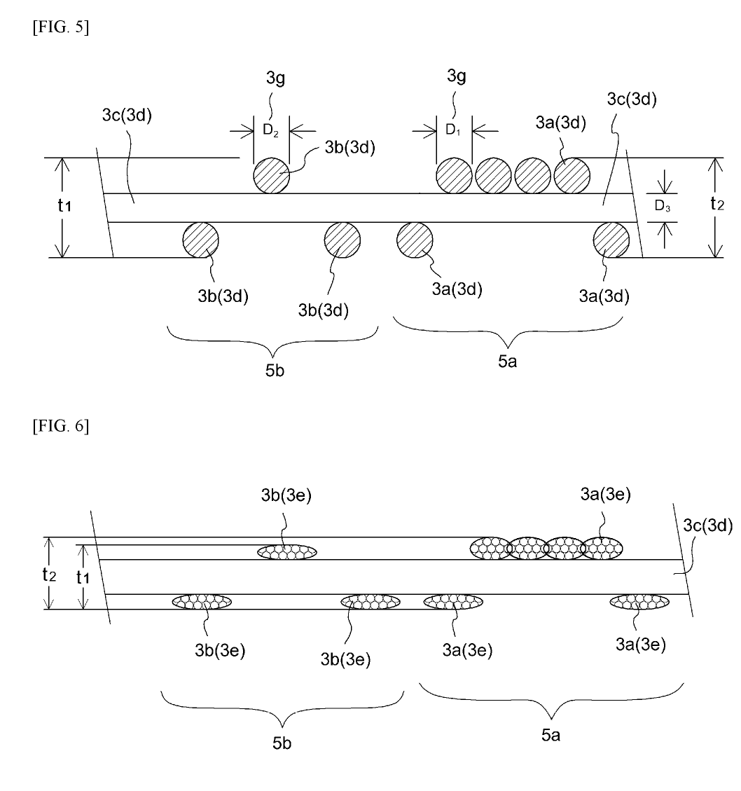

An embodiment in accordance with claim 2 of the present invention will next be described. The woven fabric comprising the plain weave (2a) used to form the sealing member (1) for preventing leakage of powder (6) which comprises woven fabric in accordance with the present embodiment has striped appearance (4) comprising step(s) (5), the high-thickness side (5a) of this step (5) being a location at which, as shown in FIG. 3, the plain weave (2a) is tightly woven such that three or more, e.g., the four shown at the left side at the front and one to either side thereof at the back for a total of six in the present example, warp yarns (3a) woven in a pattern of high density and formed from yarn comprising spun continuous yarn (3e) formed by spinning a plurality of continuous fibers and/or spun discontinuous yarn (3f) formed by spinning a plurality of discontinuous fibers are arranged in continuously adjacent fashion so as to cross two weft yarns (3c). On the other hand, at the low-thickness side (5b) of step (5), as shown in FIG. 4, two or less, e.g., one in the present example, warp yarn(s) (3b) woven in a pattern of low density and formed from yarn comprising spun continuous yarn (3e) and/or spun discontinuous yarn (3f) formed by spinning a plurality of fibers is/are loosely woven, considerable space being created between it/them and its/their adjacent neighbor(s), so as to cross the weft yarn(s) (3c) and produce woven pattern (2b) of the plain weave (2a) shown in FIG. 3. Note that as shown in FIG. 5, D₁, which is the diameter (3g) of the warp yarn (3a) at the high-thickness side (5a) of the step (5), and D₂, which is the diameter (3g) at the low-thickness side (5b) of the step, are identical, which is to say that D₁=D₂, when unstretched. However, when sealing member (1) formed from this plain weave (2a) is subjected to pressure during use, as shown in FIG. 6, at the front of the sealing member (1), the high-thickness side (5a) is such that the cross-section of the warp yarn (3a) becomes deformed in slightly flattened fashion at the front under the influence of tension from the weft yarn (3c). In such case, because adjacent warp yarns (3a) mutually interfere with each other, deformation such as would cause a high degree of flattening is suppressed, and density is made higher at woven pattern (2b) at the high-thickness side (5a) where thickness is t₂. Moreover, as shown in FIG. 6, in the event that warp yarn (3a) and warp yarn (3b) both comprise multifilament yarn, at woven pattern (2b) at the low-thickness side (5b) where thickness is t₁, the cross-section of the warp yarn (3b) will be deformed in flattened fashion at the front under the influence of tension from the weft yarn (3c) to a much greater degree than was the case at the foregoing high-thickness side (5a). That is, at woven pattern (2b) at the low-thickness side (5b), because no adjacent warp yarn(s) (3b) is/are present, there can be no mutual interference between warp yarns (3b), and woven pattern (2b) is more greatly deformed in a direction such as will cause the width of the warp yarn (3b) to undergo flattening than is the case at the high-thickness side (5a), causing the height thereof in the thickness direction to be made smaller, such that the woven pattern (2b) is formed so as to have low density and small thickness. On the other hand, at the back of the sealing member (1), because no adjacent warp yarn(s) (3a) or warp yarn(s) (3b) is/are present at either the high-thickness side (5a) or the low-thickness side (5b), there can be no mutual interference, and so, under the influence of tension from the weft yarn (3c), both are deformed in such fashion that they are flattened to thicknesses that are smaller than at the front. By thus causing two types of woven patterns (2b) comprising a high-thickness side (5a) and a low-thickness side (5b) to be arranged in alternating fashion, a woven pattern (2b) of banded and striped appearance (4) is formed which has steps (5) due to difference in height caused by difference in deformation in the thickness direction.

Next, yarn for warp yarn (3a) which was to be woven in a pattern of high density and which had diameter D₁ and yarn for warp yarn (3b) which was to be woven in a pattern of low density and which had diameter D₂, both of which comprised monofilament yarn (3d) and were of identical diameter, which is to say that D₁=D₂, and weft yarn (3c) which comprised monofilament yarn (3d) and was of diameter D₃, were prepared, and woven fabric made in plain weave (2a) for forming sealing member (1) was formed from this warp yarn (3a) which was to be woven in a pattern of high density, this warp yarn (3b) which was to be woven in a pattern of low density, and this weft yarn (3c). Here, as can be seen at FIG. 5, thickness t₁ at locations in the plain weave (2a) where warp yarns (3b) woven in a pattern of low density were present, and thickness t₂ at locations in the plain weave (2a) where warp yarns (3a) woven in a pattern of high density were present, were the same thickness, which is to say that t₁=t₂.

An embodiment in accordance with claim 3 of the present invention will moreover be described. In contradistinction to the foregoing embodiment in accordance with claim 2 at which, in a woven fabric comprising a plain weave (2a) for a sealing member (1) for preventing leakage of powder (6) which comprised woven fabric, and in which D₁, which was yarn diameter (3g) in the height direction of the high-thickness side (5a) of step (5), was identical to D₂, which was yarn diameter (3g) in the height direction of the low-thickness side (5b) thereof (which is to say that diameter D₁ in the height direction=diameter D₂ in the height direction), the present embodiment is such that D₁, which is the diameter (3g) of warp yarns (3a) at the high-thickness side, is deformed to less degree in the height direction than D₂, which is the diameter (3g) of warp yarns (3a) at the low-thickness side, these forming woven pattern (2b) of banded and striped appearance (4) and having step(s) (5), so that yarn diameter (3g) in the height direction is therefore large, which is to say that the yarn used for formation thereof is spun continuous yarn (3e) comprising a plurality of continuous fibers, and/or is spun discontinuous yarn (3f) comprising a plurality of discontinuous fibers, for which diameter D₁ in the height direction>D₂ in the height direction. Moreover, at this woven pattern (2b) of banded and striped appearance (4) and having step(s) (5) comprising yarn of spun continuous yarn (3e) and/or spun discontinuous yarn (3f) wherein yarn diameter (3g) in the height direction is large, three or more warp yarns (3a) for which D₂, which is the yarn diameter (3g) in the height direction where high-thickness side (5a) is formed, is large, are arranged in adjacent or proximate fashion, the mesh so formed being such that it bends less easily than where woven pattern (2b) comprises two or less warp yarns (3b) for which D₁, which is the yarn diameter (3g) in the height direction at the low-thickness side (5b) in the woven pattern (2b) of banded and striped appearance (4), is small.

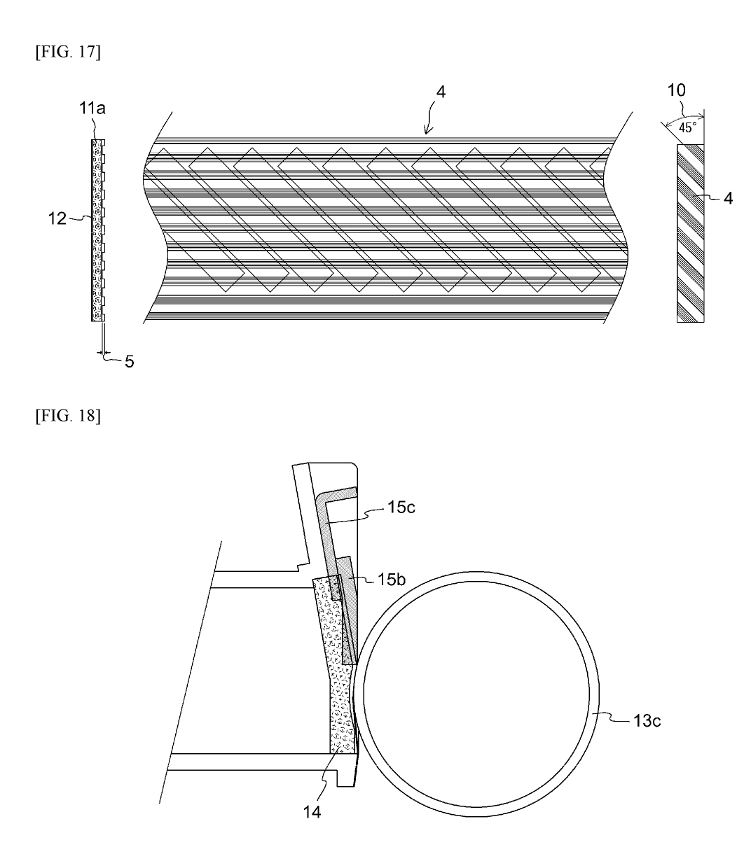

An embodiment in accordance with claim 4 of the present invention will moreover be described. In the present embodiment, in the context of a sealing member (1) for preventing leakage of powder (6) and comprising woven fabric as at the foregoing embodiment in accordance with claim 3, in an application in which the sealing member (1) is employed at a rotating body (7), the woven fabric made in plain weave (2a) shown in FIG. 7 which will be the sealing member (1) is formed as the sealing member (1) by punching or cutting as indicated with solid line in the drawing at center in FIG. 16 or at center in FIG. 17 in such fashion as to cause the direction of the bands and stripes (4) of the woven pattern (2b) which has banded and striped appearance (4) and which has steps (5) to be inclined at a prescribed control angle (10) shown at center in FIG. 16 or at center in FIG. 17 relative to the direction of rotation (7a) of the rotating body (7) (develop roller (13a)) at which it is to be employed. By then causing the sealing member (1) cut from this woven fabric made in plain weave (2a) to abut an end portion (8a) of the powder carrier (8) which is a rotating body (7) so as to constitute an end seal member (14), leakage of powder (6) to the exterior from location(s) where the powder carrier (8) which constitutes the rotating body (7) is abutted by the sealing member (1) which is end seal member (14) is prevented. Shown at center in FIG. 16 are locations to be punched out therefrom in a situation where the control angle (10) of stripes (4) is 10°, and shown at center in FIG. 17 are locations to be punched out therefrom in a situation where the control angle (10) of stripes (4) is 45°. Moreover, shown at right in FIG. 16 is a plan view of a sealing member (1) which has been formed by punching this out therefrom in a situation where the control angle (10) of stripes (4) is 10°, and shown at right in FIG. 17 is a plan view of a sealing member (1) which has been formed by punching this out therefrom in a situation where the control angle (10) of stripes (4) is 45°. The backs of these sealing members (1) have elastic bodies (11a), the sectional view at left in FIG. 16 showing an example in which two-sided adhesive tape (12) is present at the backs of the elastic bodies (11a), and the sectional view at left in FIG. 17 showing an example in which two-sided adhesive tape (12) is not present at the backs of the elastic bodies (11a). At the drawing shown at left in FIG. 16 and the drawing shown at left in FIG. 17, note that the difference in height between the high-thickness side (5a) and the low-thickness side (5b) at stripe (4) corresponds to step (5).

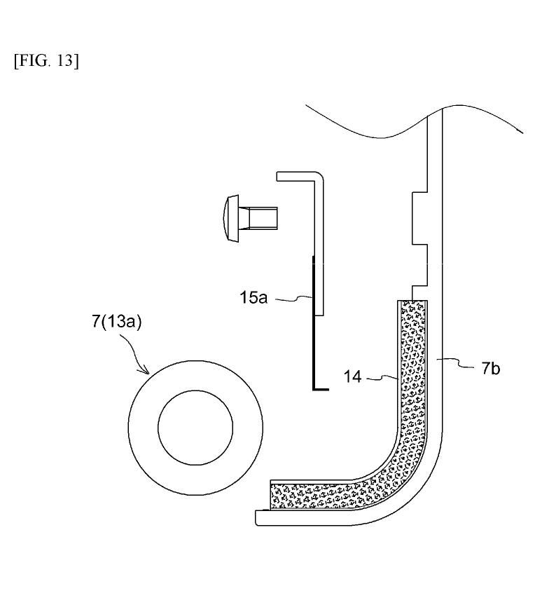

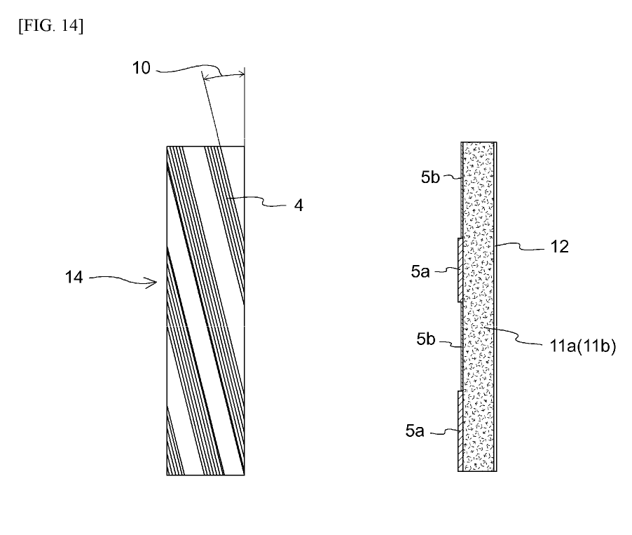

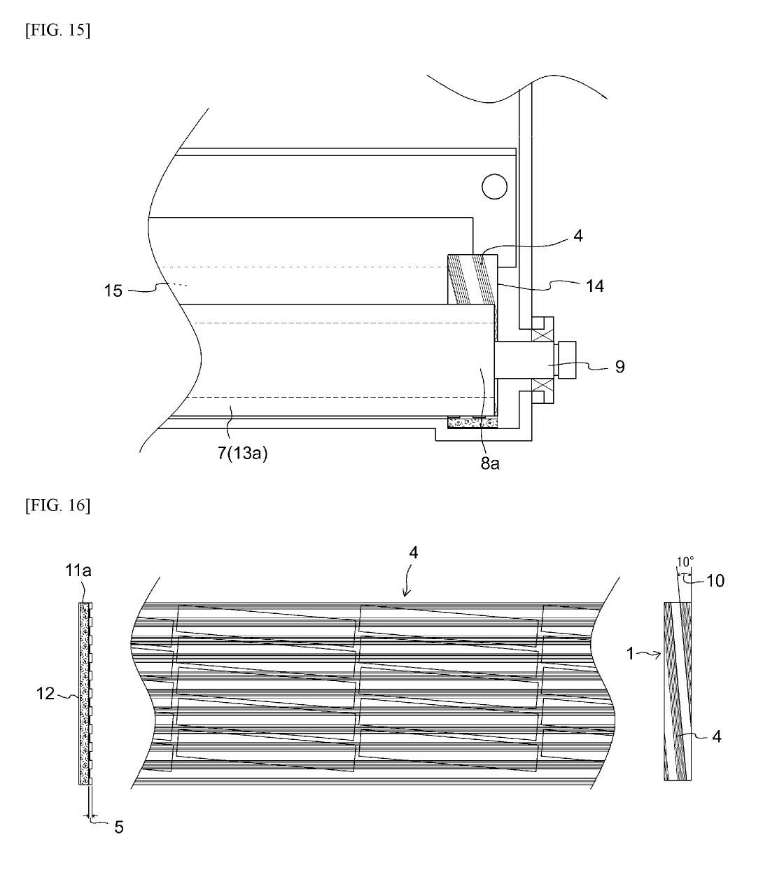

An embodiment in accordance with claim 5 of the present invention will moreover be described. In the present embodiment, in the context of a sealing member (1) for preventing leakage of powder (6) and comprising woven fabric as at the foregoing embodiment in accordance with claim 4, a sealing member (1) formed so as to be inclined at a prescribed control angle (10) relative to the direction of rotation (7a) of the rotating body (7) at which it is to be employed, as shown at right in FIG. 14, is such that elastic body (11a) or foamed body (11b) having cushioning characteristics is arranged at the back of the sealing member (1), and two-sided adhesive tape (12) is made to adhere to this elastic body (11a) or foamed body (11b). The two-sided adhesive tape (12) at this sealing member (1) is made to adhere to a support member (7b) of the rotating body (7) so as to support the rotating body (7) and cause a prescribed load to be borne thereby, which makes it possible to achieve prevention of leakage of powder. Moreover, this FIG. 13 shows in exploded fashion an end portion of a rotating body (7) which is a developer carrier, i.e., develop roller (13a), in an electrophotographic apparatus (13), an end seal member (14) which is affixed to a support member (7b) which supports the end portion of the develop roller (13a) being in particular shown therein; shown at left in FIG. 14 is an end seal member (14) having striped appearance (4), a side view of what is shown at left being shown at right in FIG. 14; and FIG. 15 is a drawing in which end seal member (14) is arranged in an application in which it is employed at the end portion at the shaft portion (9) side of rotating body (7), i.e., of develop roller (13a).

An embodiment in accordance with claim 6 of the present invention will moreover be described. This is such that the sealing member (1) for preventing leakage of powder (6) formed from woven fabric at any one of the foregoing embodiments in accordance with claims 1 through 5 has a film on a surface of the sealing member (1) which is formed by rubbing thereon a waxy substance comprising an ester of a higher alcohol and a higher fatty acid which is a wax and/or a paraffin or a fatty acid salt comprising metallic soap and/or bar soap which is solid matter. Because this sealing member (1) has a waxy substance or metallic soap and/or bar soap on a surface thereof, it has extremely satisfactory lubricity. Accordingly, there being no occurrence of raggedness or loss of fibers at the surface of the sealing member (1) during use, it will have excellent wear resistance and will not experience detachment therefrom. It will therefore be possible to prevent leakage of powder (6) from powder carrier (8) which constitutes rotating body (7) over long periods of time.

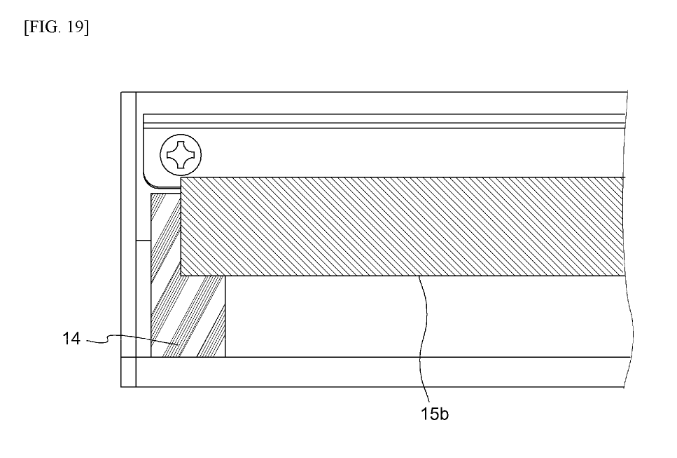

An embodiment in accordance with claim 7 of the present invention will moreover be described. The sealing member (1) for preventing leakage of powder (6) comprising woven fabric of any one of the above-described embodiments in accordance with claims 1 through 6 is employed in an application in which it serves as end seal member (14) that prevents leakage to the exterior of powder (6) which is toner (6a) from a develop roller (13a) which is a developer carrier roller (13b) at a developing device in an electrophotographic apparatus (13). In addition, FIG. 18 shows a side view of an end seal member (14) provided in such fashion as to abut a lower end portion of a cleaning blade (15b) which is attached to a blade support member (15c) which is a bracket, in a situation where the member being cleaned comprises a photosensitive drum (13c) which is an image carrier; and FIG. 19, in a drawing which is a front view of that which is shown at FIG. 18 but in which the photosensitive drum (13c) has been removed to show the blade support member (15c) which is the bracket, the cleaning blade (15b) which is attached therebelow, and the end seal member (14) which is provided at an end portion therebehind.

### Working Example 1

To further describe the sealing member (1) of the present invention in terms of working examples, as shown in FIG. 1 and TABLE 1, a needle loom was used to fabricate woven fabric made in plain weave (2a) and having banded and striped appearance (4) in which the number of yarns combined at warp yarns (3a) was varied to obtain three varieties of steps (5), these being Sample A, Sample B, and Sample C. The woven fabrics fabricated in this fashion were then treated by applying a coating to the backs thereof. This coating treatment was carried out as desired to accommodate the stiffness of elastic body (11a) or foamed body (11b) to be affixed to the back of the sealing member (1) comprising woven fabric having banded and striped appearance (4). In the present working example, the sealing member (1) was such that the back of the woven fabric was subjected to coating treatment, following which the elastic body (11a) was affixed thereto, and the woven fabric to which this elastic body (11a) had been affixed was then cut so as to cause the stripes (4) thereof to be inclined at the desired control angle (10), to fabricate the sealing member (1). Constitutions of these woven fabric samples were as shown at TABLE 1, warp yarns (3a), warp yarns (3b), and weft yarns (3c) all being Nylon (trade name for polyamide fiber). Note, however, that there is no objection to employment of synthetic fibers or artificial fibers other than Nylon, or to natural fibers, for warp yarns (3a), warp yarns (3b), and weft yarns (3c). Furthermore, for all samples, the weft yarns (3c) comprised 56-tex monofilament yarn (3d).

At TABLE 1, Sample A was such that the first warp yarns (3b) thereof comprised ISO-standard 78-tex 17-filament multifilament yarn, and the second warp yarns (3a) thereof comprised ISO-standard 56-tex 17-filament multifilament yarn. The weft yarns (3c) comprised 56-tex monofilament yarn. Accordingly, the first warp yarns (3b) were heavier, and had larger yarn diameter (3g), than the second warp yarns (3a). However, the second warp yarns (3a) were such that six thereof were arranged in continuously adjacent fashion so that together with the weft yarns (3c) in the weft direction they formed a plain weave (2a), being constituted so as to cause the weft yarns at this location to have maximum density, such that flattening of the woven yarn and/or spreading of multifilaments making up the woven yarn was suppressed, and thickness t₂ of the woven second warp yarns (3a) was 0.22 mm; while because the density with which warp yarns (3b) serving as first warp yarns (3b) were woven was low, the first warp yarns (3b) being such that there were no adjacent or proximate warp yarn(s) present, there was no suppression of flattening and/or spreading of multifilaments making up the woven yarn due to tension from weft yarns (3c) and tension from warp yarns, such that thickness t₁ thereof was 0.17 mm, causing the steps (5) of banded and striped appearance (4), i.e., t₂ minus t₁, to be 0.05 mm.

Sample B at TABLE 1 was such that the first warp yarns (3b) thereof comprised ISO-standard 78-tex 17-filament multifilament yarn, and the second warp yarns (3a) thereof comprised ISO-standard 78-tex 24-filament multifilament yarn. The weft yarns (3c) comprised 56-tex monofilament yarn. Accordingly, first warp yarns (3b) and second warp yarns (3a) were of the same weight, but the number of filaments in the multifilament yarn was greater for the second warp yarns (3a) than for the first warp yarns (3b). Accordingly, because fiber density at the first warp yarns (3b) was lower than fiber density at the second warp yarns (3a), and the first warp yarns (3b) were of larger yarn diameter, thickness t₁ of the woven first warp yarns (3b) was 0.18 mm, and thickness t₂ of the woven second warp yarns (3a) was 0.26 mm, causing the steps (5) of banded and striped appearance (4), i.e., t₂ minus t₁, to be 0.08 mm, which meant that the steps (5) of banded and striped appearance (4) here were larger than at Sample A.

Sample C at TABLE 1 was such that the first warp yarns (3b) thereof comprised ISO-standard 78-tex 17-filament multifilament yarn, and the second warp yarns (3a) thereof comprised ISO-standard 122-tex 30-filament multifilament yarn. The weft yarns (3c) comprised 56-tex monofilament yarn. Accordingly, the first warp yarns (3b) were lighter than the second warp yarns (3a). The number of filaments in the multifilament yarn was greater for the second warp yarns (3a) than for the first warp yarns (3b). Accordingly, because the second warp yarns (3a) were of even lower fiber density, but of larger yarn diameter, than the first warp yarns (3b), thickness t₂ of the woven second warp yarns (3a) was 0.32 mm, and thickness t₁ of the woven first warp yarns (3b) was 0.17 mm, causing the steps (5) of banded and striped appearance (4), i.e., t₂ minus t₁, to be 0.15 mm, which meant that the steps (5) of banded and striped appearance (4) at Sample C were largest, being even larger than at Sample B.

TABLE 1
Woven Fabric Constitution and Steps

| Constitution | | Sample A | Sample B | Sample C |
|---|---|---|---|---|
| | | Has steps due to | Has steps due to | Has steps due to |
| | | effect of density of | effect of diameter | effect of diameter |
| | | 2nd warp yarn | and density of 2nd | and density of 2nd |
| | | | warp yarn | warp yarn |
| Yarn | First warp | Nylon | Nylon | Nylon |
| Material | yarn 3b | 78T/17F | 78T/17F | 78T/17F |
| | Second warp | Nylon | Nylon | Nylon |
| | yarn 3a | 56T/17F | 78T/24F | 122T/30F |
| | Weft yarn 3c | Nylon | Nylon | Nylon |
| | | 56T/(monofilament) | 56T/(monofilament) | 56T/(monofilament) |

| | | | |
|---|---|---|---|
| Weft Density (rows/cm) | | | |
| Loom | Needle-Type | Needle-Type | Needle-Type |
| Thickness: t1 (mm) | 0.17 | 0.18 | 0.17 |
| (where 1st warp yarn used) | | | |
| Thickness: t2 (mm) | 0.22 | 0.26 | 0.32 |
| (where 2nd warp yarn used) | | | |
| Step: H = t2 − t1 | 0.05 | 0.08 | 0.15 |
| (mm) | | | |

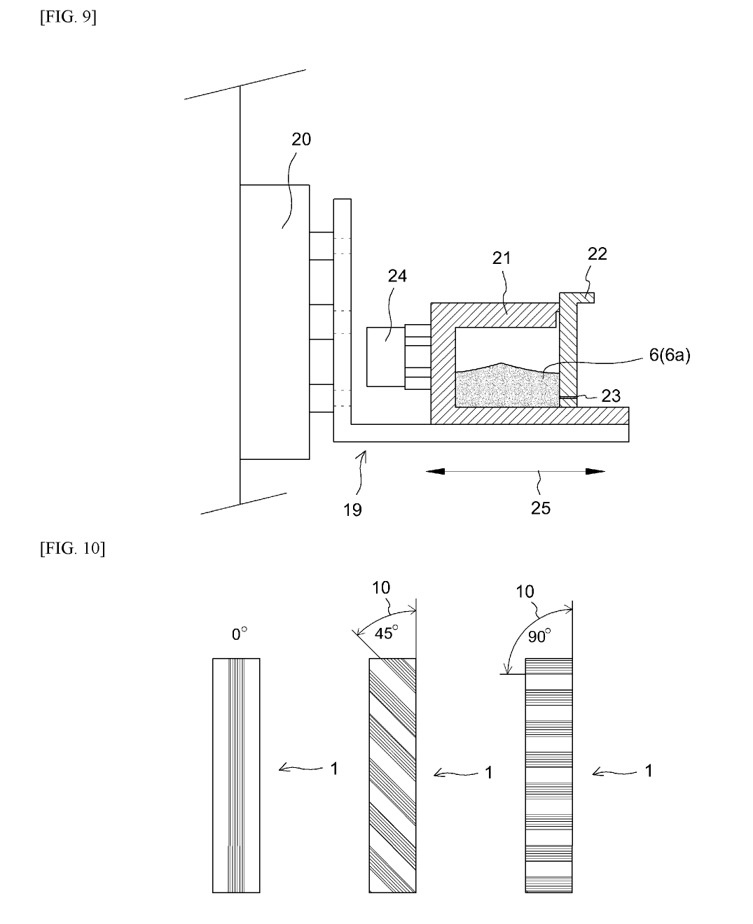

Next, using four varieties of steps (5), these being the foregoing Sample A, Sample B, and Sample C, and an additional sample for which the step (5) was 0.11 mm, the vibration testing machine (19) shown in FIG. 9 was used to carry out leakage testing as indicated at TABLE 2, TABLE 3, and TABLE 4 by varying abutting seal load among three values at an end seal (23) beneath a vertical cover (22) in a powder container (21), a vibrator (20) being used to apply vibrations to the powder container (21) so as to cause it to vibrate in the direction indicated by the arrow (25), at which time, while carrying out detection with a sensor (24), toner (6a) comprising polymer which was powder (6) of diameter 6μ was made to undergo acceleration due to the vibration that was applied thereto, trials for which toner (6a) leaked to the exterior from the bottom of the end seal (23) when acceleration due to vibration was less than 40 G being indicated by an “X”, and trials for which leakage did not occur at 40 G being indicated by an “O”, at TABLE 2, TABLE 3, and TABLE 4. At this toner (6a) leakage testing, the control angle (10) of sealing member (1) which comprised bands and stripes (4) was set to the angles at the three sealing members (1) shown in FIG. 10, these being 0°, 45°, and 90°, leakage testing being moreover carried out by varying abutting seal load at end seal (23) among three values for each of these three control angles (10). At TABLE 2, TABLE 3, and TABLE 4, below, note that “O” indicates trials for which leakage of toner did not occur when acceleration due to vibration was 40 G, and “X” indicates trials for which leakage of toner occurred at an acceleration due to vibration that was under 40 G.

First, leakage testing was carried out on four varieties of end seals (23) having steps (5) that were 0.05 mm, 0.08 mm, 0.11 mm, and 0.15 mm, abutting seal load at end seal (23) at vibration testing machine (19) being varied among three values, these being 20 g/cm², 30 g/cm², and 100 g/cm², and control angle (10) at end seal (23) which comprised bands and stripes (4) being set to 0° as shown at left in FIG. 10. Results are shown in TABLE 2. As shown at TABLE 2, with end seals (23) having steps (5) that were 0.05 mm, 0.08 mm, 0.11 mm, and 0.15 mm, for all three values of abutting seal load, there was no leakage of toner when acceleration due to vibration was 40 G, this fact being indicated by “O” at TABLE 2. That is, when control angle was 0°, for all four varieties of end seals (23) having different steps (5), leakage of toner did not occur at an acceleration due to vibration of 40 G regardless of the difference in the steps (5). It was therefore confirmed, for abutting seal loads of not more than 100 g/cm², that the end seals (23) which had a control angle of 0° were capable of preventing leakage of toner at an acceleration due to vibration of 40 G.

TABLE 2
Vibration Testing: When Control Angle 10 of Sealing Member Was 0°

| | Abutting Seal Load | Abutting Seal Load | Abutting Seal Load |
|---|---|---|---|
| | 20 (g/cm²); | 30 (g/cm²); | 100 (g/cm²); |
| Step | at time of | at time of | at time of |
| (mm) | application of load | application of load | application of load |
| 0.05 | ◯ | ◯ | ◯ |
| 0.08 | ◯ | ◯ | ◯ |
| 0.11 | ◯ | ◯ | ◯ |
| 0.15 | ◯ | ◯ | ◯ |

Next, leakage testing was carried out on four varieties of end seals (23) having steps (5) that were 0.05 mm, 0.08 mm, 0.11 mm, and 0.15 mm, abutting seal load at end seal (23) at vibration testing machine (19) being varied among three values, these being 100 g/cm², 200 g/cm², and 300 g/cm², and control angle (10) at end seal (23) which comprised bands and stripes (4) being set to 45° as shown at center in FIG. 10. Results are shown in TABLE 3. As shown at TABLE 3, with end seals (23) having steps (5) that were 0.05 mm, 0.08 mm, and 0.11 mm, for all three values of abutting seal load, there was no leakage of toner when acceleration due to vibration was 40 G, this fact being indicated by “O” at TABLE 3. However, for steps (5) that were 0.15 mm, with abutting seal loads of 100 g/cm² and 200 g/cm², leakage did occur, and sealing capability was inadequate, at accelerations due to vibration that were under 40 G, this fact being indicated by “X” at TABLE 3. On the other hand, with an abutting seal load of 300 g/cm², leakage of toner occurred when acceleration due to vibration was 40 G, this fact being indicated by “O” at TABLE 3. These results confirm that, when control angle (10) at the end seal (23) was 45° and with an abutting seal load of 300 g/cm², there was no leakage of toner at accelerations due to vibration that were under 40 G and there was adequate ability to prevent leakage of toner for steps (5) that were 0.05 mm to 0.15 mm.

TABLE 3
Vibration Testing: When Control Angle 10 of Sealing Member Was 45°

| | Abutting Seal Load | Abutting Seal Load | Abutting Seal Load |
|---|---|---|---|
| | 100 (g/cm²); | 200 (g/cm²); | 300 (g/cm²); |
| Step | at time of | at time of | at time of |
| (mm) | application of load | application of load | application of load |
| 0.05 | ◯ | ◯ | ◯ |
| 0.08 | ◯ | ◯ | ◯ |
| 0.11 | ◯ | ◯ | ◯ |
| 0.15 | X | X | ◯ |

Moreover, abutting seal load at end seal (23) at the vibration testing machine (19) was varied among three values, these being 20 g/cm², 300 g/cm², and 550 g/cm², and control angle (10) at the end seal (23) which comprised bands and stripes (4) was set to 90° as shown at right in FIG. 10, the results being shown at TABLE 4. The results at TABLE 4 indicate that for steps (5) that were 0.05 mm, there was no leakage of toner at an acceleration of 40 G for any of the abutting seal loads, this fact being indicated by “O” at TABLE 4. However, for steps (5) that were 0.08 mm to 0.15 mm, with an abutting seal load of 300 g/cm², leakage of toner occurred in all cases at accelerations due to vibration that were under 40 G, which fact is indicated by “X”, and seal capability was inadequate. In contradistinction hereto, with an abutting seal load of 550 g/cm², for steps (5) that were 0.08 mm and 0.11 mm, there was no leakage of toner at an acceleration due to vibration of 40 G or higher, this fact being indicated by “O” at TABLE 4. On the other hand, even with an abutting seal load of 550 g/cm², for steps (5) that were 0.15 mm, leakage of toner did occur at an acceleration due to vibration that was under 40 G, this fact being indicated by “X” at TABLE 4. That is, when control angle (10) at the end seal (23) was 90° and with an abutting seal load of 550 g/cm², there was no leakage of toner when acceleration due to vibration was 40 G for steps (5) that were 0.05 mm to 0.11 mm. However, even with an abutting seal load of 550 g/cm², for steps that were 0.15 mm, leakage of toner did occur at an acceleration due to vibration that was under 40 G. The foregoing results of testing indicated at TABLE 2, TABLE 3, and TABLE 4 confirmed that without provision of control angle (10) at sealing member (1), the functionality of the step would be unmanifested, and there would be inadequate ability to prevent leakage.

TABLE 4
Vibration Testing: When Control Angle 10 of Sealing Member Was 90°

| | Abutting Seal Load | Abutting Seal Load | Abutting Seal Load |
|---|---|---|---|
| | 20 (g/cm²); | 300 (g/cm²); | 550 (g/cm²); |
| Step | at time of | at time of | at time of |
| (mm) | application of load | application of load | application of load |
| 0.05 | ◯ | ◯ | ◯ |
| 0.08 | X | X | ◯ |
| 0.11 | X | X | ◯ |
| 0.15 | X | X | X |

Next, as shown in FIG. 15, in the context of an actual production machine having an end seal member (14) at a develop roller (13a), i.e., developer carrier roller (13b), comprising a rotating body (7), i.e., powder carrier (8), in an electrophotographic apparatus (13), further testing of effectiveness in terms of seal characteristics at this end seal member (14) was carried out by setting surface velocity of the developer carrier roller (13b) to 250 mm/sec and varying control angle (10) as shown at left in FIG. 14. As a result, as shown at TABLE 5, it was confirmed that the sealing member (1) of banded and striped appearance (4) and having steps (5) making up the woven fabric made in plain weave (2a) of the present invention had an effectiveness which was absent in conventional seal members comprising pile products. That is, by causing the control angle (10) of the bands and stripes (4) to be in a direction such as will result in sealing of powder, and causing abutting of portions where stripes (4) are present to occur in such fashion as to be located where sealing is needed and/or in such direction as to cause steps (5) to be made small, even where abutting load is as low as 60 g/cm², this will constitute a sealing member (1) comprising woven fabric made in plain weave (2a) and capable of acting as a seal, that had not existed conventionally, which is an excellent sealing member (1) even when employed as an end seal member (14) at a powder carrier (8) constituting a rotating body (7) in an electrophotographic apparatus (13). Note that abutting load 300 g/cm² at TABLE 5 is an ordinary abutting load for an electrophotographic apparatus (13), and that under conditions of this abutting load, there was excellent sealing effect for all of the varieties of steps (5) when control angle (10) of the bands and stripes (4) was 0.5° to 90°. That is, trials marked “O” at TABLE 5 indicate trials for which the end seal member (14) was effective as a seal whether employed at the inner edge portion of control blade (15a) or at the outer edge portion thereof, while trials marked “X” at TABLE 5 indicate trials for which the end seal member (14) caused toner (6a) to leak to the exterior and was ineffective as a seal. Note that the conventional part listed in TABLE 5 was a sealing member formed from a woven pile fabric.

TABLE 5
Results of Seal Leakage Testing
(Actual Production Machine: Roller Surface Velocity = 250 mm/sec)

| | | | | | | | Conventional |
|---|---|---|---|---|---|---|---|
| | | | | | | | Woven |
| | | | | | | | Pile |
| | Sample A | | Sample B | | Sample C | | Fabric |
| Angle of | Step: H = 0.06 | | Step: H = 0.09 | | Step: H = 0.15 | | — |
| Bands | (mm) | | (mm) | | (mm) | | |
| (Control | | | | | | | |
| Angle) | | | | | | | |
| | Abutting | Abutting | Abutting | Abutting | Abutting | Abutting | Abutting |
| | Load | Load | Load | Load | Load | Load | Load |
| Units (°) | 60 (g/cm²) | 300 (g/cm²) | 60 (g/cm²) | 300 (g/cm²) | 60 (g/cm²) | 300 (g/cm²) | 300 (g/cm²) |
| −0.5 | X | X | X | X | X | X | X |
| 0 | ◯ | ◯ | ◯ | ◯ | ◯ | ◯ | X |
| 0.5 | ◯ | ◯ | ◯ | ◯ | ◯ | ◯ | X |
| 5 | ◯ | ◯ | ◯ | ◯ | ◯ | ◯ | X |
| 10 | ◯ | ◯ | ◯ | ◯ | ◯ | ◯ | X |
| 20 | ◯ | ◯ | ◯ | ◯ | ◯ | ◯ | X |
| 30 | ◯ | ◯ | ◯ | ◯ | ◯ | ◯ | ◯ |
| 40 | ◯ | ◯ | ◯ | ◯ | ◯ | ◯ | ◯ |
| 45 | ◯ | ◯ | ◯ | ◯ | ◯ | ◯ | ◯ |
| 50 | ◯ | ◯ | ◯ | ◯ | ◯ | ◯ | ◯ |
| 60 | ◯ | ◯ | ◯ | ◯ | ◯ | ◯ | ◯ |
| 70 | ◯ | ◯ | ◯ | ◯ | ◯ | ◯ | ◯ |
| 90 | X | ◯ | X | ◯ | X | ◯ | ◯ |

Sealing members (1) in accordance with the present invention may be constituted such that they are fabricated with desired pitch(es) P, i.e., distance(s), between neighboring warp yarns (3b) shown in FIG. 8 as well as warp yarns (3a) in the woven yarns at and width(s) W of bands and stripes (4) having steps (5) shown in FIG. 8, and it is possible to utilize the steps (5) in such fashion that the sealing member (1) also exhibits a guiding function due to presence of the steps (5). Moreover, this may also be used in such fashion that it functions as an end seal member (14) at a supply roller which is linked by an intermediate belt (16a) with a rotating body (7) in an electrophotographic apparatus (13) and an end seal member (14) at a photosensitive body, or as an end seal member (14) at a developer carrier roller (13b), i.e., develop roller (13a), which is a powder carrier (8) constituting a rotating body (7) in an electrophotographic apparatus (13).

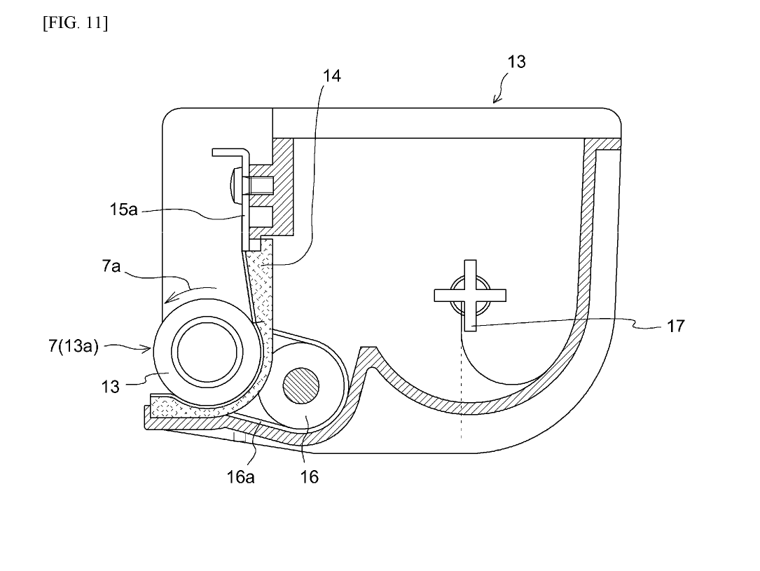

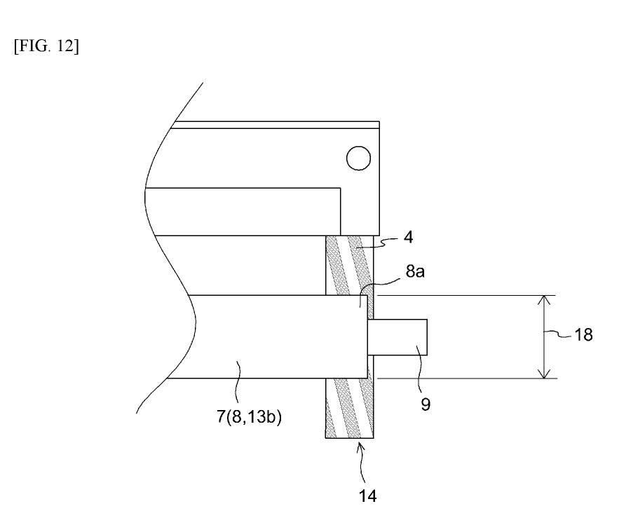

In the context of the foregoing means, as means for carrying out prevention of leakage of powder (6) at lower load, it will be more effective to use a sealing member (1) for which the steps (5) at the stripes (4) are low rather than high. In such case, it will be important to causing abutting to occur in such fashion that portions with bands and stripes (4) having steps (5) are made to be present at locations which are intended to be sealed. Accordingly, as shown in FIG. 12, when a prescribed step (5) serves as sealing member (1) at a powder carrier (8) constituting a rotating body (7) in an electrophotographic apparatus (13), still more effectiveness in terms of ability to function as a seal and prevent leakage at low loads may be obtained by causing the region (18) abutted by the sealing member (1) to be abutted thereby in helical fashion by portions of stripes (4) having steps (5), and still more effectiveness in terms of sealing ability may be obtained by arranging this so as to be directed toward the end edge portion of the cleaning blade (15b) shown in FIG. 18 or the control blade (15a) for toner (6a) at develop roller (13a) shown in FIG. 13 of the electrophotographic apparatus (13) in such fashion as to cause the stripes (4) having these steps (5) to be inclined at the control angle (10). Moreover, at FIG. 11, agitator (17), being a member that agitates toner (6a) which is powder (6) constituting electrophotographic developer, supplies toner (6a) from supply roller (16) which is driven by intermediate belt (16a) to a developer carrier roller (13b) which is develop roller (13a). In addition, if the rotational speed of powder carrier (8) is high, the dust cloud from powder (6) generated during rotation will result in the dust cloud from powder (6) adhering to the seal region which is the region (18) where this abuts powder carrier (8) shown in FIG. 12, with contamination occurring as a result thereof. However, by causing the region of bands and stripes (4) having steps (5) at end seal member (14) to abut the region (18) abutted thereby, i.e., the seal region, in helical fashion, and by causing it to do so in such fashion that it protrudes to a location that is at or beyond the end face of the powder carrier (8), even if contamination should occur due to a dust cloud from powder (6), the region (18) abutted thereby will be cleaned by the bands and stripes (4) having steps (5), making it possible for the seal region to be maintained in satisfactory condition. Note that the woven yarn used at the means of the present invention may be spun discontinuous yarn (3f), spun continuous yarn (3e), and/or monofilament yarn (3d) which may be continuous fibers comprising synthetic fibers, it being possible to choose the material(s) employed therefor as desired.

### EXPLANATION OF REFERENCE NUMERALS

1 Sealing member
2a Plain weave
2b Woven pattern
3a Warp yarn (woven in a pattern of high density)
3b Warp yarn (woven in a pattern of low density)
3c Weft yarn
3d Monofilament yarn
3e Spun continuous yarn
3f Spun discontinuous yarn
3g Yarn diameter
4 Stripe
5 Step
5a High-thickness side
5b Low-thickness side
6 Powder
6a Toner
7 Rotating body
7a Direction of rotation
7b Support member
8 Powder carrier
8a End portion
9 Shaft portion
10 Control angle
11a Elastic body
11b Foamed body
12 Two-sided adhesive tape
13 Electrophotographic apparatus
13a Develop roller
13b Developer carrier roller
13c Photosensitive drum (image carrier)
14 End seal member
15a Control blade
15b Cleaning blade
15c Blade support member (bracket)
16 Supply roller
16a Intermediate belt
17 Agitator (agitation member)
18 Abutted region
19 Vibration testing machine
20 Vibrator
21 Powder container
22 Vertical cover
23 End seal
24 Sensor
25 Direction of vibration

1. In the context of a sealing member for preventing leakage of powder, a sealing member for preventing leakage of powder comprising woven fabric characterized in that it is a sealing member of woven fabric comprising warp yarn and weft yarn, being woven from at least three or more types of yarn; in that it comprises at least two or more different warp yarn diameters and/or different woven warp yarn pattern densities; and in that it comprises woven fabric woven into a pattern having banded and striped appearance having steps due to this difference in warp yarn diameters and/or this difference in woven warp yarn pattern densities.

2. The sealing member for preventing leakage of powder comprising woven fabric according to claim 1 characterized in that the woven fabric woven into a pattern having banded and striped appearance having steps is such that the pattern of banded and striped appearance is formed from steps between high-thickness sides and low-thickness sides; wherein the high-thickness side of each of said steps is formed such that not less than three woven warp yarns comprising spun continuous yarn formed by spinning a plurality of continuous fibers and/or spun discontinuous yarn formed by spinning a plurality of discontinuous fibers are arranged in continuously adjacent and/or proximate fashion so that the warp yarn density in the weft direction is higher than at the low-thickness side, as a result of which flattening of the warp yarn cross-section and/or spreading of fibers forming the warp yarn is suppressed, and deformation in the warp yarn height direction is decreased; wherein the low-thickness side of each of said steps is formed such that low warp yarn density, there being not more than two woven warp yarns comprising spun continuous yarn and/or spun discontinuous yarn and there being little tendency toward suppression of spreading of fibers forming the warp yarn and/or flattening of cross-section, causes spreading of fibers forming the warp yarn and/or flattening in a direction such as will increase width of the warp yarn to be promoted more than at the high-thickness side, and causes height in the thickness direction to be decreased; and wherein alternating arrangement of these two different warp yarn densities causes the woven pattern to be of banded and striped appearance having steps from difference in height in the thickness direction due to degree of spreading of fibers that form the warp yarn and/or degree of flattening constituting difference in deformation in the thickness direction.

3. The sealing member for preventing leakage of powder comprising woven fabric according to claim 2 characterized in that the not less than three woven warp yarns comprising spun continuous yarn formed by spinning a plurality of continuous fibers and/or spun discontinuous yarn formed by spinning a plurality of discontinuous fibers are formed from woven spun continuous yarn and/or woven spun discontinuous yarn having larger warp yarn diameter at the high-thickness sides than warp yarn diameter at the low-thickness sides which form the woven pattern of banded and striped appearance having steps; wherein a woven mesh of banded and striped appearance resulting from arrangement in proximate and/or adjacent fashion of not less than three of these woven warp yarns of continuous yarn and/or discontinuous yarn having large diameter is formed so as to bend less easily than a woven mesh comprising not more than two woven warp yarns comprising yarn having small diameter.

4. The sealing member for preventing leakage of powder comprising woven fabric according to claim 3 characterized in that, when the woven fabric comprising the woven pattern of banded and striped appearance having steps is used as a sealing member in an application at a rotating body, the sealing member is formed by cutting and/or punching that woven pattern so as to cause a direction of the bands and stripes to be inclined at a prescribed control angle relative to a direction of rotation of the rotating body at which it is employed; and causing said sealing member to abut an end portion of a powder carrier which constitutes the rotating body prevents leakage of powder to the exterior from a location between a region abutted by the sealing member and the powder carrier which constitutes the rotating body.

5. The sealing member for preventing leakage of powder comprising woven fabric according to claim 4 characterized in that a foamed body and/or an elastic body having cushioning characteristics is arranged at a back of the sealing member formed so as to be inclined at the prescribed control angle relative to the direction of rotation of the rotating body at which it is employed.

6. The sealing member for preventing leakage of powder comprising woven fabric according to claim 1 characterized in that the sealing member for preventing leakage of powder comprising woven fabric is such that, on a surface of woven yarn comprising spun discontinuous yarn formed by spinning a plurality of discontinuous fibers or spun continuous yarn formed by spinning a plurality of continuous fibers or monofilament yarn constituting continuous fibers from which that sealing member is formed, there is a film formed by rubbing thereon a waxy substance comprising an ester of a higher alcohol and a higher fatty acid which is a wax and/or a paraffin or a fatty acid salt constituting metallic soap and/or bar soap comprising solid matter.

7. The sealing member for preventing leakage of powder comprising woven fabric according to claim 1 characterized in that the sealing member for preventing leakage of powder comprising woven fabric is a sealing member at a powder carrier constituting a rotating body in an electrophotographic apparatus.

8. The sealing member for preventing leakage of powder comprising woven fabric according to claim 2 characterized in that the sealing member for preventing leakage of powder comprising woven fabric is such that, on a surface of woven yarn comprising spun discontinuous yarn formed by spinning a plurality of discontinuous fibers or spun continuous yarn formed by spinning a plurality of continuous fibers or monofilament yarn constituting continuous fibers from which that sealing member is formed, there is a film formed by rubbing thereon a waxy substance comprising an ester of a higher alcohol and a higher fatty acid which is a wax and/or a paraffin or a fatty acid salt constituting metallic soap and/or bar soap comprising solid matter.

9. The sealing member for preventing leakage of powder comprising woven fabric according to claim 3 characterized in that the sealing member for preventing leakage of powder comprising woven fabric is such that, on a surface of woven yarn comprising spun discontinuous yarn formed by spinning a plurality of discontinuous fibers or spun continuous yarn formed by spinning a plurality of continuous fibers or monofilament yarn constituting continuous fibers from which that sealing member is formed, there is a film formed by rubbing thereon a waxy substance comprising an ester of a higher alcohol and a higher fatty acid which is a wax and/or a paraffin or a fatty acid salt constituting metallic soap and/or bar soap comprising solid matter.

10. The sealing member for preventing leakage of powder comprising woven fabric according to claim 4 characterized in that the sealing member for preventing leakage of powder comprising woven fabric is such that, on a surface of woven yarn comprising spun discontinuous yarn formed by spinning a plurality of discontinuous fibers or spun continuous yarn formed by spinning a plurality of continuous fibers or monofilament yarn constituting continuous fibers from which that sealing member is formed, there is a film formed by rubbing thereon a waxy substance comprising an ester of a higher alcohol and a higher fatty acid which is a wax and/or a paraffin or a fatty acid salt constituting metallic soap and/or bar soap comprising solid matter.

11. The sealing member for preventing leakage of powder comprising woven fabric according to claim 5 characterized in that the sealing member for preventing leakage of powder comprising woven fabric is such that, on a surface of woven yarn comprising spun discontinuous yarn formed by spinning a plurality of discontinuous fibers or spun continuous yarn formed by spinning a plurality of continuous fibers or monofilament yarn constituting continuous fibers from which that sealing member is formed, there is a film formed by rubbing thereon a waxy substance comprising an ester of a higher alcohol and a higher fatty acid which is a wax and/or a paraffin or a fatty acid salt constituting metallic soap and/or bar soap comprising solid matter.

12. The sealing member for preventing leakage of powder comprising woven fabric according to claim 2 characterized in that the sealing member for preventing leakage of powder comprising woven fabric is a sealing member at a powder carrier constituting a rotating body in an electrophotographic apparatus.

13. The sealing member for preventing leakage of powder comprising woven fabric according to claim 3 characterized in that the sealing member for preventing leakage of powder comprising woven fabric is a sealing member at a powder carrier constituting a rotating body in an electrophotographic apparatus.

14. The sealing member for preventing leakage of powder comprising woven fabric according to claim 4 characterized in that the sealing member for preventing leakage of powder comprising woven fabric is a sealing member at a powder carrier constituting a rotating body in an electrophotographic apparatus.

15. The sealing member for preventing leakage of powder comprising woven fabric according to claim 5 characterized in that the sealing member for preventing leakage of powder comprising woven fabric is a sealing member at a powder carrier constituting a rotating body in an electrophotographic apparatus.

16. The sealing member for preventing leakage of powder comprising woven fabric according to claim 6 characterized in that the sealing member for preventing leakage of powder comprising woven fabric is a sealing member at a powder carrier constituting a rotating body in an electrophotographic apparatus.
